(19) United States
(12) Patent Application Publication
(10) Pub. No.: US 2005/0222923 A1
(43) Pub. Date: Oct. 6, 2005

(54) Disbursement system

(75) Inventor: William K. Lambright, St. Louis, MO (US)

Correspondence Address: HUSCH & EPPENBERGER, LLC, 190 CARONDELET PLAZA, SUITE 600, ST. LOUIS, MO, 63105-3441, US

(73) Assignee: Abstar Disbursing Company, St. Louis, MO (US)

(21) Appl. No.: 11/070,761

(22) Filed: Mar. 2, 2005

Related U.S. Application Data
(60) Provisional application No. 60/549,365, filed on Mar. 2, 2004.

(51) Int. Cl. G06F 17/60

(52) U.S. Cl. 705/30; 705/35

(57) ABSTRACT

An internet based disbursement system allows all interested parties to a project contract, including, in the case of a construction project, the buyer, lender, disbursing agent, title company, and general contractor, to follow the progress of the project and separate tasks making up the project as well as the disbursement of funds to different vendors associated with the project.

### CROSS-REFERENCE TO RELATED APPLICATIONS

This application claims the priority of provisional application Ser. No. 60/549,365, filed Mar. 2, 2004.

### TECHNICAL FIELD OF THE INVENTION

This invention relates generally to a project tracking system and, more particularly, to an internet based project and disbursement monitoring system.

### DESCRIPTION OF THE RELATED ART

The construction field is, by its very nature, an ever-changing area. The government, private sector, and general public engage in construction activities at an ever-increasing rate. Many professionals are involved in construction projects including buyers, contractors, subcontractors, materialmen, and lenders.

Construction tracking systems, in the past, have been plagued by logistical errors and a lack of real-time information. Due to the number of entities involved with construction projects and the interdependency of the entities, a computer-based tracking system for the construction industry that provides real-time information would be very helpful. Because of this, it is desirous to develop a disbursement system with these characteristics.

### SUMMARY OF THE INVENTION

In accordance with the above aspects of the invention, there is provided a disbursement system that is drawn to a funds or payables disbursement software program primarily developed for the construction industry. In a preferred embodiment, the disbursement software is an internet based system. The system allows all interested parties to a construction contract, including the buyer, lender, disbursing agent, title company, and general contractor to follow the progress of construction and disbursement of funds to subcontractors and the general contractor directly through the Internet. An aspect of the present invention is to provide a disbursement system capable of real-time coordination of verification of task completion, disbursement of funds, and job status updates.

In accordance with these aspects, a method of tracking the disbursement of funds to users and corresponding progress on a project that involves multiple tasks is provided that comprises the steps of providing a network accessible system to a set of users, said network accessible system defining a project account having separate task sub-accounts corresponding to said multiple tasks and a project funding sub-account corresponding to funds allocated to completion of said project; permitting a first user of said set of users to access said system and upload information to said project funding sub-account to reflect funds allocated to completion of said project to date; permitting a second user of said set of users to access said system and upload information to a first task sub-account to reflect progress made on a first task corresponding to said first task sub-account to date; permitting a third user of said set of users to review said first task sub-account to determine the progress made on said task corresponding to said first task sub-account and to upload information to said project finding sub-account and to said first task sub-account to reflect a payment to said second user from said funds allocated to completion of said project; and permitting one of said set of users to access said project account and review each of said project funding sub-account and said task sub-accounts to determine progress made on each of said tasks, payments made to said second user, mechanic's lien waivers collected, and remaining funds allocated to completion of said project.

An electronic system for tracking the disbursement of funds to users and corresponding progress on a project that involves multiple tasks is provided that comprises a server in communication with a network and having a central processor and a memory; a database stored in said memory; said database containing a project account having separate task sub-accounts corresponding to said tasks and a project funding sub-account corresponding to funds allocated to completion of said project; a log stored in said memory, said log being automatically updated when a first user uploads a submittal to said memory and when a second user performs an action on said submittal; and a network communication protocol device in said server and communicating with said central processor and said memory, said network communication protocol device permitting said users to access, upload information to, and review said project account and said task sub-accounts and project funding sub-account.

These aspects are merely illustrative of the various aspects associated with the present invention and should not be deemed as limiting in any manner. Further features and advantages of the present invention will become apparent from the following detailed description when taken in conjunction with the referenced drawing.

### BRIEF DESCRIPTION OF THE DRAWINGS

Reference is now made to the drawing which illustrates the best known mode of carrying out the invention and wherein like reference numbers indicate like elements.

FIG. 1 illustrates a block diagram for a disbursement system according to an embodiment of the present invention.

FIG. 2 is a sample log-in screen for a disbursement system.

FIG. 3 is a sample project listing screen for a disbursement system.

FIG. 4 is a sample project maintenance window for a disbursement system.

FIG. 5 is a sample project category maintenance screen for a disbursement system.

FIG. 6 is a sample category disbursement history screen for a disbursement system.

FIG. 7 is a sample project statement report request screen for a disbursement system.

FIG. 8 is a sample project summary report request screen for a disbursement system.

FIG. 9 is a sample vouchers screen for a disbursement system.

FIG. 10 is a sample voucher information screen for a disbursement system.

FIG. 11 is a sample bank orders screen for a disbursement system.

FIG. 12 is a sample equity orders screen for a disbursement system.

FIG. 13 is a sample inspection pictures screen for a disbursement system.

### DETAILED DESCRIPTION OF THE PREFERRED EMBODIMENTS

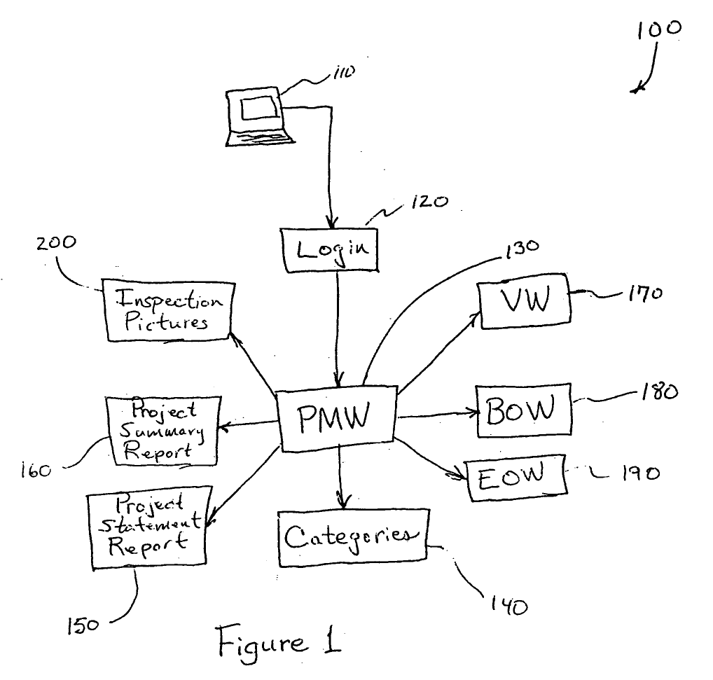

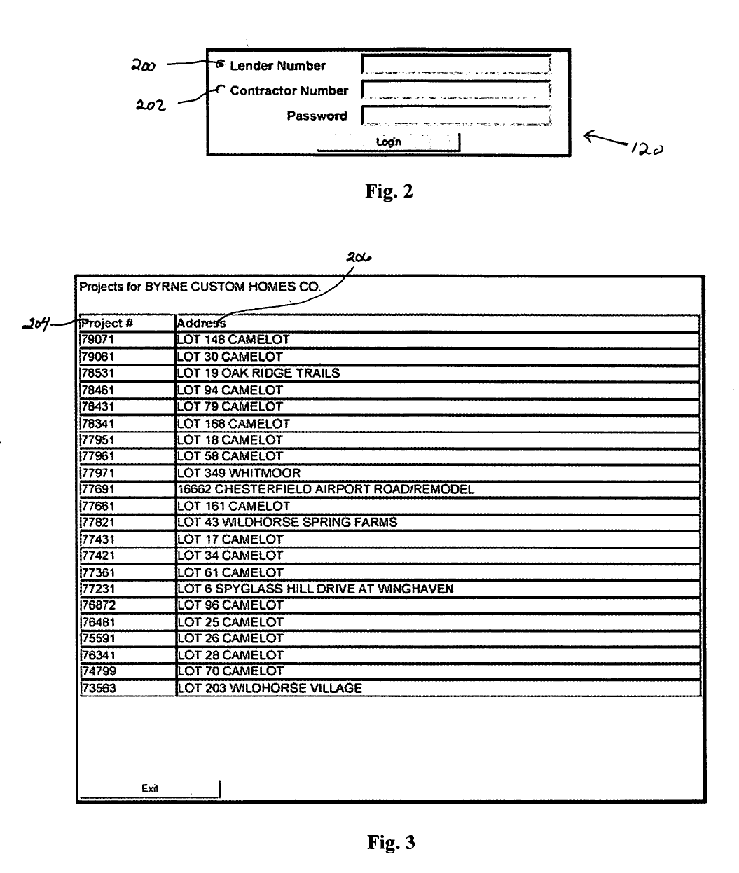

Referring to the accompanying drawings in which like reference numbers indicate like elements, FIG. 1 illustrates a block process diagram for a disbursement system. Reference character 100 generally indicates a block diagram of a disbursement system, which is a computer-based tracking system for the construction industry.

The system 100 is accessed by a user 110 through any Internet capable computer. This includes, but is not limited to, desktop, laptop, and hand held computer systems. In a preferred embodiment, the system 100 is VB.net based. The user 110 may be a lender, contractor, owner, or other party given system 100 access. Additionally, the term “user” should not be limited to one “user” as it is envisioned that a plurality of “users” may be able to enjoy the benefits of the system 100. As such, both “user” and “users” are used interchangeably without detracting from the present invention.

A login screen 120, prompts the user to enter a lender 200 or contractor 202 number. The login prompt screen 120 functions as a security feature and an identification tool with which to limit access to the system 100. Each lender or contractor is assigned a unique login number and password. It is envisioned that the terms “lender” and “contractor” will also encompass buyers, disbursing agents, general contractors, title company employees, and other entities who are granted access to the system 100 by system administration. Thus, the terms “lender” and “contractor” are generically used in the login prompt screen 120 to encompass a wide range of applicable users. Additionally, it is important to note that the terms “subcontractor” and “contractor” may be used interchangeably in the system 100 and in this description without detracting from the aspects or benefits of the present invention.

Upon login, a screen listing all projects corresponding to the particular user 110 (lender or contractor) is displayed. The screen lists each project by project number 204 as well as an address field 206. The user 110 then selects the project he or she is interested in tracking by double-clicking on either the project 204 or address 206 field. By selecting a particular project, a project maintenance window (PMW) 130 is executed and displayed for the particular project.

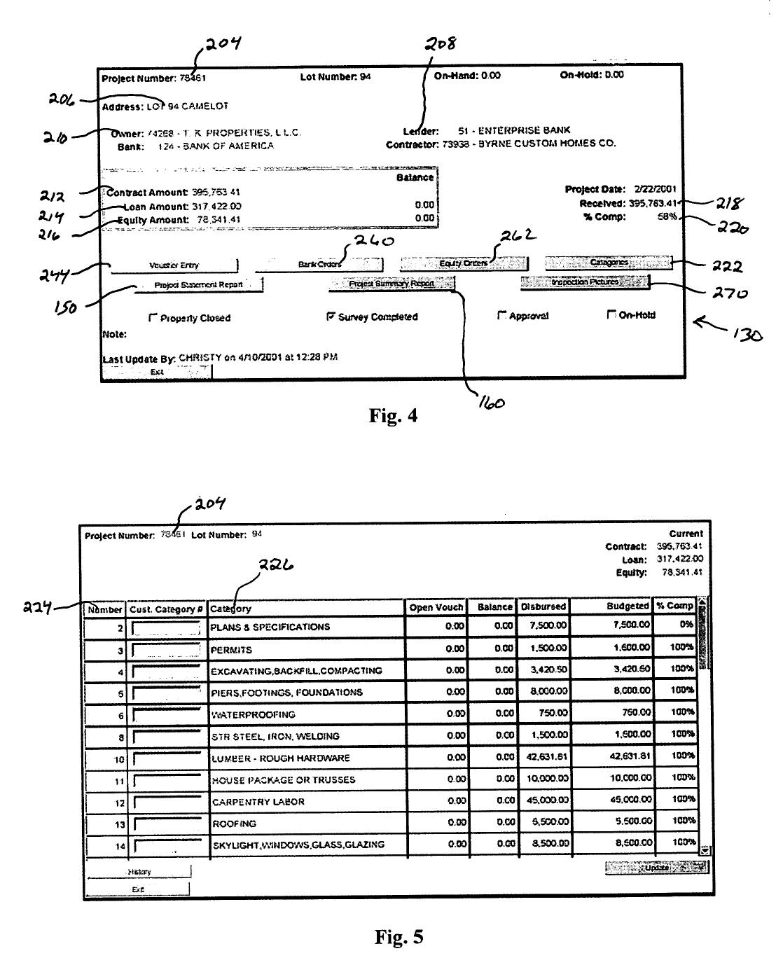

The PMW 130 functions as a particular project's main information directory. Each individual project has a unique PMW 130. As depicted in FIG. 1, the system 100 is centralized. The PMW 130 is used to access all information for the project. As illustrated in FIG. 4, information shown in the PMW 130 includes, but is not limited to, the project number 204, land description (lot number and address), lender name 208, and owner name 210. Additionally, the overall project financial status is shown. The financial status includes the contract amount balance 212, loan amount 214, and equity amount 216. Likewise, total loan payments received 218 are shown as well as an overall percent of the project completed 220 as determined by a construction inspector. In one embodiment, a note field near the bottom of the PMW 130 contains project specific instructions for system users 110. The note field is entered by system administrators to direct users 110 regarding specific construction aspects. An example of such instructions would include the proper protocol for voucher approval.

A powerful aspect of the system 100 is that the PMW 130 allows the user 110 to be connected, in real time, to multiple parameters associated with particular projects. The system's 100 real-time capabilities or timeliness is a function of when information is entered into the system and depends on the rights given to the various users 110 and the equipment available. As an example, users 110 having input capabilities may be able to enter information into the system 100 using handheld devices. In this instance, if a user 110 having input capabilities is at a construction site and enters information into a handheld device simultaneously as events are occurring, information on the system 100 cannot be any more current. Thus, system 100 information can be entered by a variety of users 110 from a variety of locations using a variety of input sources or equipment.

Users 110 may selectively view information related to voucher entries, bank orders, equity orders, construction category tracking, project statement reports, project summary reports, and inspection pictures. Users 110 view this information simply by selectively clicking upon a button linking the user to the specific information the user is interested in viewing.

Completion of individual categories by subcontractors can be tracked. This is beneficial because, depending on the number of subcontractors involved, keeping real-time tabs on completed categories can greatly ease project management activities, especially when several subcontractors are involved. The user 110 selectively chooses a Categories button 222 from the PMW 130 to view construction category information.

The user 110 is directed to a project category maintenance screen, shown in FIG. 5, after selectively choosing the Categories button 222 from the PMW 130. Construction projects, by their very nature, have several subparts, or mini-projects occurring, often at the same time. Thus, it is beneficial to be able to effectively track each subpart in order to keep abreast of scheduling and financial data. The project category maintenance screen allows the user 110 to view all the various subparts or mini-projects within the overall construction project.

Each subpart has a unique number 224 and name 226 corresponding to construction related work or purchases. As an example, the number “4” may correspond to excavating, backfilling, and compacting activities while the number “10” corresponds to lumber and tar paper purchases. As a result, the system 100 allows users 110 to effectively focus or pinpoint their query to the exact information they are interested in viewing.

Payments made to the subcontractors by the lender(s) through a disbursing agent are tracked. Likewise, construction material payments to materialmen are also tracked. Financial disbursements for each individual category are tracked against voucher amounts that have been received for each individual category and a corresponding budgeted amount. This allows the user 110, at the click of a mouse, to view the project and get an overall real-time project picture (financial and construction tasks) in one screen. As a result, the user 110 can view financial expenditures to date and earmarked funds remaining to be spent for each category, as well as mechanic's lien waivers collected. Additionally, the real-time completion percentage for each category is tracked as determined by the construction inspector. This allows the user 110 to, at the click of a mouse, determine how much of the project is completed.

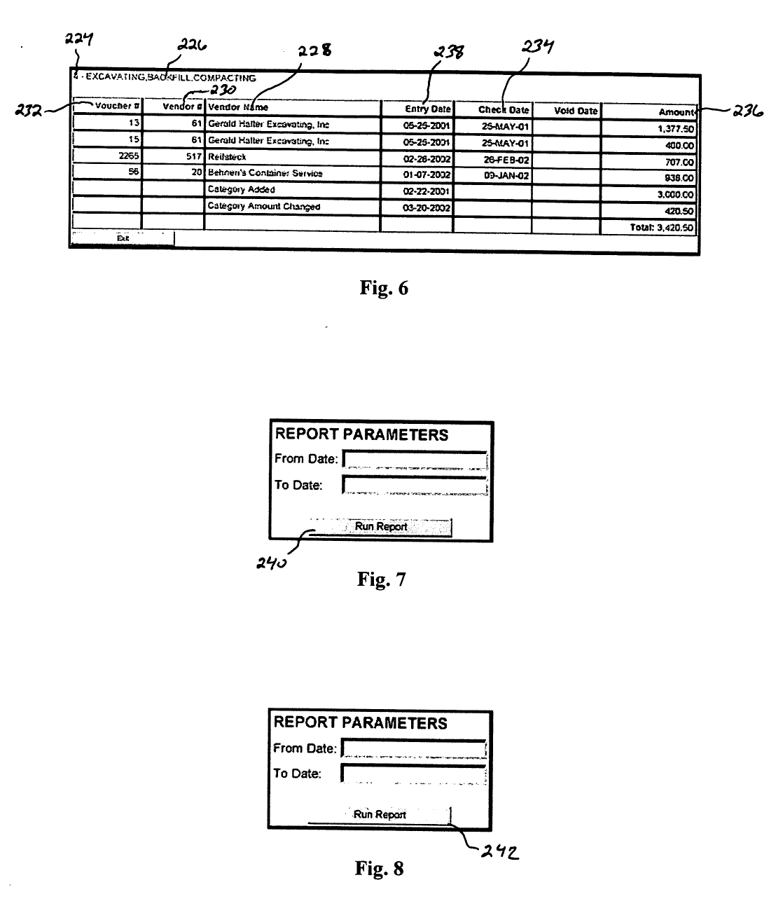

Financial discrepancies often arise in construction projects and, as a result, it is beneficial to track subcontractor payments. The user 110 selectively accesses this information by choosing the construction category he or she is interested in viewing. As an example, the user 110 may be interested in viewing all information pertaining to excavation, backfilling, and compaction. The user 110 simply double clicks the particular construction category he or she is interested in viewing. A Disbursements and History for this Category Window (DHCW), shown in FIG. 6, is then opened.

The DHCW shows all contractors and subcontractors involved with the particular construction category. Each contractor or subcontractor is delineated by vendor name 228 and number 230. A corresponding voucher number 232, along with the date a check was issued to the vendor 234, and the amount of the check 236 is tracked. Likewise, the date 238 the information was entered into the system 100 is shown in the DHCW.

The user 110 may access further detailed information on a date specific basis by selecting a Project Statement Report 150 button in the PMW 130. Upon selecting the Project Statement Report 150 button, a dialog box is displayed, as shown in FIG. 7, which queries the user to select a date range in a field for viewing the detailed information. The user 110 may enter a date range in a mm/dd/yyyy format. Should the user 110 wish to view the information from project inception to the present, the user simply leaves the field empty. Upon selecting a Run Report button 240, the project statement report is displayed as an Adobe Acrobat file. The project statement report is very detailed and contains all relevant information pertaining to construction categories and descriptions, completion percentages, vouchers submitted, and financial information such as individual category balances.

Equity and loan fund information is summarized in a project report. The user 110 accesses the project summary by selecting a Project Summary Report 160 button in the PMW 130. As with the project statement report 150, a dialog box, shown in FIG. 8, is displayed that queries the user 110 to select a date range in a field for viewing the detailed information. The user 10 may enter a date range in a mm/dd/yyyy format. Should the user 110 wish to view the information from project inception to the present, the user simply leaves the field empty. Upon selecting a Run Report button 242, the project statement report is displayed as an Adobe Acrobat file.

The equity and loan information in the project summary report 160 is listed by date and tracks total loan and equity funds, the amount of those funds received, and the remaining balances. Receipt and disbursement columns with respective descriptions of project-related information are shown in the project summary report 160. Users 110 may, therefore, use the project summary report 160 to view the construction project's financial status without wading through technical information that may be beyond the required scope in a given instance.

A comparison of each contract line-item budget category is tracked. The comparison is facilitated by viewing the project category maintenance screen. The comparison is tracked to an actual amount disbursed per each contract line-item budget category. This is a very beneficial feature because it allows users 110 to compare, on a real-time basis, actual amounts expended versus budgeted amounts.

A completion date for each construction category is tracked by reviewing the project statement report 150. In addition to percentage completed, a date is provided in the project statement report coinciding with the percentage completed amount. Thus, system 100 users 110 simply access the project statement report 150 to track completion dates. In the past, the only way for interested parties to obtain information was for periodic visits or phone calls to contractors and managers. Coordinating schedules of interested parties was difficult and, as a result, information was not always timely. This useful feature, therefore, allows interested parties to access timely construction information.

A payment date, a payment amount, and a respective check number to the subcontractors and general contractors are tracked. Discrepancies often arise in construction projects over payment information. This useful feature allows users to timely resolve payment discrepancies. Users 110 access this information through the PMW 130 by selecting the Voucher Entry button 244.

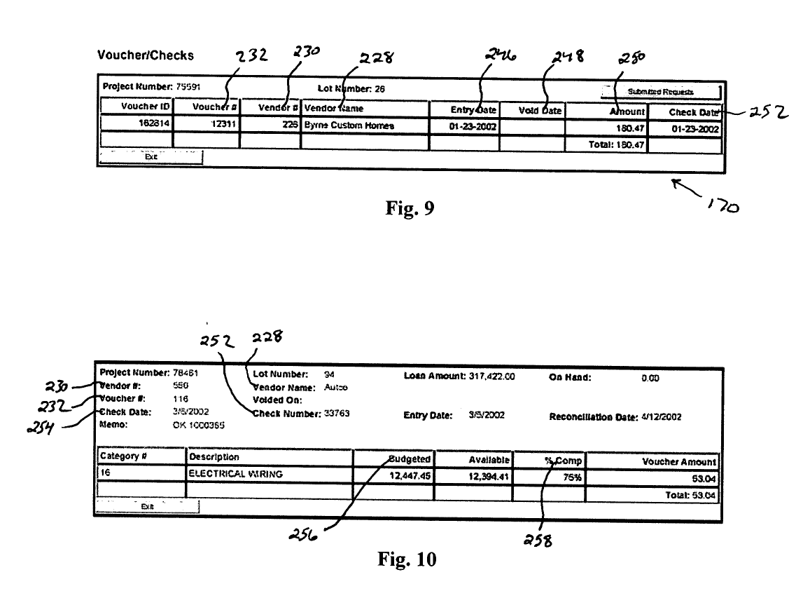

General construction voucher information is displayed in a Vouchers Window (VW) 170, shown in FIG. 9, for the entire project by voucher number 232, vendor number 230, vendor name 228, entry date 246, void date 248 (if applicable), voucher amount 250, and check date 252. Users 110 may make a specific request for viewing detailed information by double-clicking on any of the shown fields in the VW 170. This greatly assists with the overall project management tasks inherent in all construction projects.

Specific voucher information is contained in a Voucher Information Window (VIW), shown in FIG. 10. The information, in addition to vendor number 230 and vendor name 228, includes the individual check number 252 and the date 254 each check was written to a specific vendor. Likewise, the construction category budgeted amount 256 is also shown in the VIW. Additionally, the construction project completion percentage 258 is shown as determined by the construction inspector.

The receipt of mechanics lien waivers from contractors, subcontractors, and materialmen are also tracked. Numerous parties have financial security interests in construction projects. This useful feature allows users 110 to timely access financial security interest information, including bank, voucher, and equity information, and resolve pending issues. This information is accessed by selecting either a Bank Orders 260 or an Equity Orders button 262 from the PMW 130.

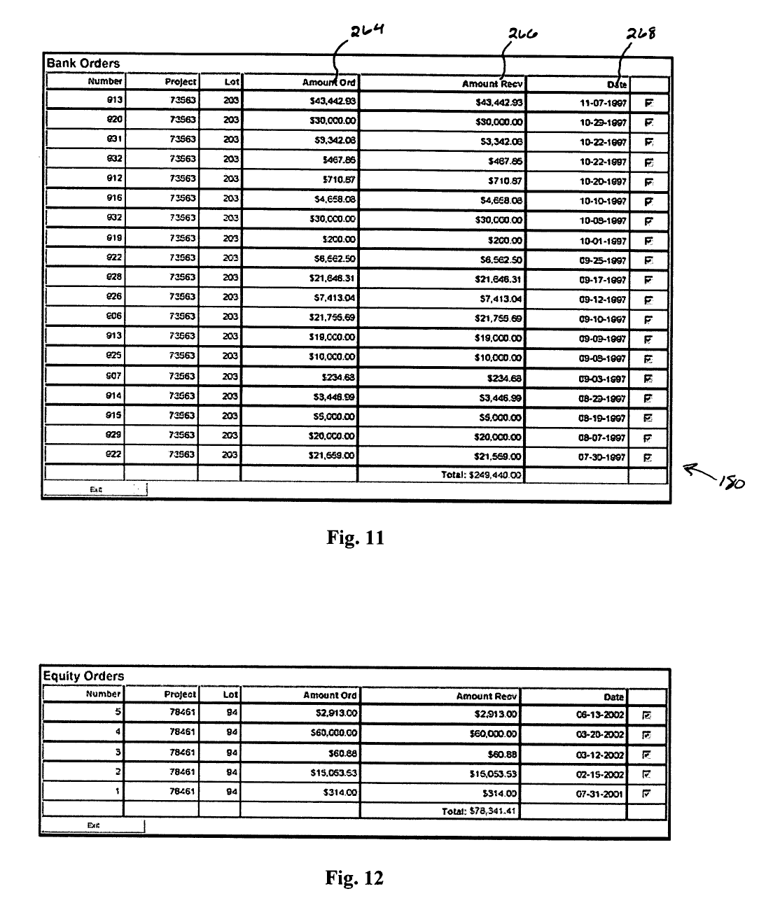

A Bank Orders Window (BOW) 180, shown in FIG. 11, accessed by selecting the Bank Orders button 260 in the PMW 130, displays all bank orders on a project by project basis. The information contains the amount ordered 264, the amount received 266, and the date the amount was received 268. Users 110 may further select a particular field for each order number to view detailed bank order information and compare the amount received versus the loan balance. This greatly assists project management staff in assessing the overall project financing and helps users 110, such as owners, effectively track real-time bank order information on their own (without calling bank or construction officials).

An Equity Orders Window (EOW) 190, shown in FIG. 12, accessed by selecting the Equity Orders button 262 in the PMW 130, displays owner contributions to the project. Owners typically earmark certain assets to construction projects in addition to loan financing. The EOW 190 tracks amounts ordered and received against the owner earmarked contributions on a project by project basis. As with the BOW 180, the EOW 190 greatly assists project management. Project management staff are able to determine, based on reviewing the EOW 190 in conjunction with the BOW 180, whether sufficient equity funds remain for specific project disbursements or, in the alternative, whether future disbursements should be issued from bank orders.

Another benefit of the invention is that the system 100 provides for digital images of the actual construction site. The images are updated on a basis agreeable with all parties as work is performed, thereby allowing the interested parties to follow the progress of construction via computer access and verify that the contractor and subcontractors have completed their individual projects with all materialmen paid. This feature saves valuable time because system 100 users 110 do not have to make phone calls or send correspondence to responsible parties to stay abreast of construction progress.

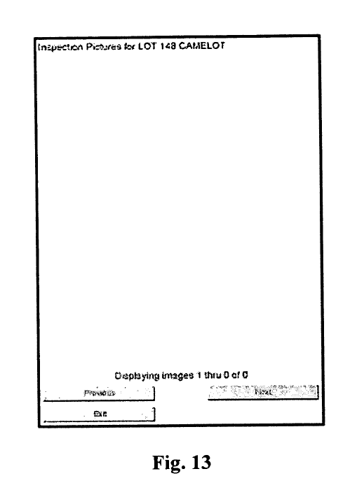

Construction related digital images are accessed by users 110 through the PMW 130 by selectively choosing an Inspection Pictures button 270. Images are then displayed along the left hand side of an Inspection Pictures window 200, an example of which is provided as FIG. 13, with corresponding dates (the date the photo was taken) displayed in fields to the right of each image. Users 10 may scroll through the images to view various aspects and features of the construction project.

It is envisioned that certain system 100 information may be displayed in more than one window. For example, individual category completion percentage is displayed in the VW 170, project category maintenance screen, and the project statement report 150. This allows users 110 to quickly access information without hunting through several windows. Additionally, the system 100 can also be set up to perform payable functions of the general contractor or any of the subcontractors.

Other objects, features, and advantages of the present invention will be apparent to those skilled in the art. While preferred embodiments of the present invention have been illustrated and described, this has been by way of illustration and the invention should not be limited except as required by the scope of the appended claims and their equivalents.

1. A method of tracking the disbursement of funds to users and corresponding progress on a project that involves multiple tasks, comprising the steps of:
providing a network accessible system to a set of users, said network accessible system defining a project account having separate task sub-accounts corresponding to said multiple tasks and a project funding sub-account corresponding to funds allocated to completion of said project;
permitting a first user of said set of users to access said system and upload information to said project funding sub-account to reflect funds allocated to completion of said project to date;
permitting a second user of said set of users to access said system and upload information to a first task sub-account to reflect progress made on a first task corresponding to said first task sub-account to date;
permitting a third user of said set of users to review said first task sub-account to determine the progress made on said task corresponding to said first task sub-account and to upload information to said project funding sub-account and to said first task sub-account to reflect a payment to said second user from said funds allocated to completion of said project; and
permitting one of said set of users to access said project account and review each of said project funding sub-account and said task sub-accounts to determine progress made on each of said tasks, payments made to said second user, and remaining funds allocated to completion of said project.

2. The method of tracking the disbursement of funds to users and corresponding progress on a project that involves multiple tasks as set forth in claim 1, further comprising the step of generating a project report at the request of said one of said set of users.

3. The method of tracking the disbursement of funds to users and corresponding progress on a project that involves multiple tasks as set forth in claim 2, wherein said step of generating a project report comprises permitting said one of said set of users to select which of said project funding sub-account and said task sub-accounts to include in said project report.

4. The method of tracking the disbursement of funds to users and corresponding progress on a project that involves multiple tasks as set forth in claim 1, further comprising the steps of:
connecting said project funding sub-account with a first bank account;
connecting said first task sub-account with a second bank account; and
transferring funds from said first bank account to said second bank account when said third user uploads information to said project funding sub-account and to said first task sub-account to reflect a payment to said second user from said funds allocated to completion of said project.

5. The method of tracking the disbursement of funds to users and corresponding progress on a project that involves multiple tasks as set forth in claim 1, wherein said task sub-accounts are organized into at least one category.

6. The method of tracking the disbursement of funds to users and corresponding progress on a project that involves multiple tasks as set forth in claim 5, further comprising the step of generating a project report at the request of said one of said set of users, wherein said one of said set of users selects from among a set of filters consisting of:
reporting a status of all task sub-accounts in said category; and
reporting a status of one of said task sub-accounts.

7. A method of tracking the disbursement of funds to sub-contractors and corresponding progress on a construction project involving multiple tasks, comprising the steps of:
providing a network accessible system to a set of users, said set of users including said sub-contractors, a disbursement coordinator, and a reviewing user, said network accessible system defining a project account having separate task sub-accounts corresponding to said tasks and a project funding sub-account corresponding to funds allocated to completion of said project;
permitting said disbursement coordinator to access said system and upload information to said project funding sub-account to reflect funds allocated to completion of said project to date;
permitting a first sub-contractor of said sub-contractors to access said system and upload information to a first task sub-account to reflect progress made on a first task corresponding to said first task sub-account to date;
permitting said disbursement coordinator to review said first task sub-account to determine the progress made on said task corresponding to said first task sub-account and to upload information to said project funding sub-account and to said first task sub-account to reflect a payment to said first sub-contractor from said funds allocated to completion of said project; and
permitting said reviewing user to access said project account and review each of said project funding sub-account and said task sub-accounts to determine progress made on each of said tasks, payments made to said first sub-contractor, and remaining funds allocated to completion of said project.

8. The method of tracking the disbursement of funds to sub-contractors and corresponding progress on a construction project as set forth in claim 7, wherein said construction project occurs at a site and further comprising the step of permitting one of said set of users to upload a photograph of said site to confirm progress of said first task.

9. The method of tracking the disbursement of funds to sub-contractors and corresponding progress on a construction project as set forth in claim 7, further comprising the step of generating a project report at the request of said one of said set of users.

10. The method of tracking the disbursement of funds to sub-contractors and corresponding progress on a construction project as set forth in claim 9, wherein said step of generating a project report comprises permitting said one of said set of users to select which of said project funding sub-account and said task sub-accounts to include in said project report.

11. An electronic system for tracking the disbursement of funds to users and corresponding progress on a project that involves multiple tasks, comprising:
means for providing a network accessible system to a set of users, said network accessible system defining a project account having separate task sub-accounts corresponding to said tasks and a project funding sub-account corresponding to funds allocated to completion of said project;
means for permitting a first user of said set of users to access said system and upload information to said project funding sub-account to reflect funds allocated to completion of said project to date;
means for permitting a second user of said set of users to access said system and upload information to a first task sub-account to reflect progress made on a task corresponding to said first task sub-account to date;
means for permitting a third user of said set of users to review said first task sub-account to determine the progress made on said task corresponding to said first task sub-account and to upload information to said project funding sub-account and to said first task sub-account to reflect a payment to said second user from said funds allocated to completion of said project; and
means for permitting one of said set of users to access said project account and review each of said project funding sub-account and said task sub-accounts to determine progress made on each of said tasks, payments made to said second user, and remaining funds allocated to completion of said project.

12. The electronic system for tracking the disbursement of funds to users and corresponding progress on a project as set forth in claim 11, further comprising means for generating a project report at the request of one of said set of users.

13. An electronic system for tracking the disbursement of funds to users and corresponding progress on a project that involves multiple tasks, comprising:
a server in communication with a network and having a central processor and a memory;
a database stored in said memory; said database containing a project account having separate task sub-accounts corresponding to said tasks and a project funding sub-account corresponding to funds allocated to completion of said project; and
a network communication protocol device in said server and communicating with said central processor and said memory, said network communication protocol device permitting said users to access, upload information to, and review said project account and said task sub-accounts and project funding sub-account.

14. The electronic system for tracking the disbursement of funds to users and corresponding progress on a project as set forth in claim 13, wherein said server is in communication with the internet.
